(19) United States
(12) Patent Application Publication
(10) Pub. No.: US 2016/0363813 A1
(43) Pub. Date: Dec. 15, 2016

(54) POLAROID, LIQUID CRYSTAL PANEL AND LIQUID CRYSTAL DISPLAY APPARATUS

(71) Applicant: SHENZHEN CHINA STAR OPTOELECTRONICS TECHNOLOGY CO., LTD., Shenzhen, Guangdong (CN)

(72) Inventors: Caiqin CHEN, Shenzhen, Guangdong (CN); Je-hao HSU, Shenzhen, Guangdong (CN)

(73) Assignee: Shenzhen China Star Optoelectronics Technology Co. Ltd., Shenzhen, Guangdong (CN)

(21) Appl. No.: 14/425,314

(22) PCT Filed: Nov. 10, 2014
(86) PCT No.: PCT/CN2014/090671

§ 371 Date: Mar. 2, 2015

(30) Foreign Application Priority Data
Nov. 4, 2014 (CN) 201410614437.4

(51) Int. Cl. G02F 1/1335; G02F 1/1368

(52) U.S. Cl. CPC G02F 1/133536; G02F 1/1368; G02F 1/133514; G02F 2001/133545; G02F 2203/02; G02F 2202/28

(57) ABSTRACT

The present invention provides a polaroid comprising a first protecting film, a polarizing film and a second protecting film which are stacked, wherein a rough structure layer and surface protecting film are sequentially disposed above the second protecting film. The present invention further provides a liquid crystal panel comprising a thin film transistor substrate, a color filter substrate disposed oppositely to the thin film transistor substrate and a liquid crystal layer disposed between the thin film transistor substrate and the color filter substrate, and the thin film transistor substrate being coupled to a first polaroid and the color filter substrate being coupled to a second polaroid, wherein the polaroid described above is adopted to be the second polaroid. Furthermore, the present invention provides a liquid crystal display apparatus comprises the liquid crystal panel described above.

### FIELD OF THE INVENTION

The present invention relates to a technique field of liquid crystal display, and more particularly to a polaroid, liquid crystal panel and liquid crystal display apparatus.

### BACKGROUND OF THE INVENTION

A liquid crystal display (LCD) is a thin flat display apparatus which comprises a certain amount of color or monochrome pixels and is disposed before a light source or a reflecting surface. Because the liquid crystal display has low power consumption and is characterized in high display quality, small size and light weight, it is favored by peoples and becomes a main display apparatus. Nowadays, the major one of the liquid crystal display is the thin film transistor (TFT) liquid crystal display.

As the area of the TFT-LCD being enlarged, a viewing angle is increased and therefore the contrast and the definition of the image is decreased. For a vertical alignment (VA) mode liquid crystal panel, the liquid crystal molecules are disposed vertically in a vertically aligned normal black mode such that the VA mode performs well in a dark state and therefore provides very high contrast in a front viewing angle. However, while being observed from side, the contrast decrease of the VA mode liquid crystal panel is obvious, color washout of an image is easily occurred, and obvious color shift phenomenon is generated under different viewing angles.

### SUMMARY OF THE INVENTION

In view of the insufficient of the conventional technique, the present invention provides a polaroid and liquid crystal panel comprising the polaroid. Through improving the structure of the polaroid, the contrast and definition under large viewing angle is improved to solve the problem of color shift phenomenon in the liquid crystal panel generated under different viewing angles.

In order to achieve the object above, the present invention adopts the technique solution below:

A polaroid comprising a first protecting film, a polarizing film and a second protecting film which are stacked, wherein a rough structure layer and a surface protecting film are sequentially disposed above the second protecting film.

Wherein, the rough structure layer at least comprises a plane and a rough surface, the plane is coupled to the second protecting film, and the rough surface is coupled to the surface protecting film.

Wherein, the rough structure layer at least comprises a plane and a rough surface, the plane is coupled to the surface protecting film, and the rough surface is coupled to the second protecting film.

Wherein, the polaroid further comprises an adhesive layer which coupled to a side of the first protecting film opposite to the polarizing film.

Wherein, a material of the polarizing film is polyvinyl alcohol.

Wherein, a material of the first protecting film and the second protecting film is triacetyl cellulose, and the material of the adhesive layer is pressure sensitive adhesive.

Wherein, a material of the rough structure layer is transparent material; the rough surface is a zigzag structure formed on a surface of the structure layer through a rubbing process, and the zigzag structure is arranged transversely and/or longitudinally to form an array structure; or the rough surface is a bump-like array formed on the surface of the structure layer through an etching process.

The present invention further provides a liquid crystal panel comprising a thin film transistor substrate, a color filter substrate disposed oppositely to the thin film transistor substrate and a liquid crystal layer disposed between the thin film transistor substrate and the color filter substrate, and the thin film transistor substrate being coupled to a first polaroid and the color filter substrate being coupled to a second polaroid, wherein the polaroid described above is adopted to be the second polaroid.

Wherein, the liquid crystal panel is a vertical alignment mode liquid crystal panel.

Another aspect of the present invention is to provide a liquid crystal display apparatus comprising a liquid crystal panel and a backlight module, the liquid crystal panel being disposed oppositely to the backlight module and a display light source being provided to the liquid crystal panel by the backlight module so as to display an image by the liquid crystal panel, wherein the liquid crystal panel described above is adopted to be the liquid crystal panel in the liquid crystal display apparatus.

Compared with the conventional technique, in the embodiment of the present invention, the structure of the polaroid at the light exit surface of the liquid crystal panel is improved by primarily adding a rough structure layer in the polaroid, such that the diffuse reflection of the emitted light is generated after reflecting and refracting the emitted light by the rough structure layer to improve the uniformity of the emitted light, increase the contrast and definition of the liquid crystal panel under large viewing angle, and solves the color shifting problem of the liquid crystal panel occurred under different viewing angles. Specifically, the rough structure layer at least comprises a plane and a rough surface. When the rough surface is disposed toward the liquid crystal layer, the diffuse reflection caused by the rough surface of the polaroid under the situation of a black mode of the liquid crystal panel can be reduced, and the color washout problem of the panel can be avoided.

### BRIEF DESCRIPTION OF THE DRAWINGS

FIG. 1 is an exemplary diagram of a liquid crystal display apparatus provided by an embodiment of the present invention.

FIG. 2 is an exemplary diagram of a liquid crystal panel provided by an embodiment of the present invention.

FIG. 3 is an exemplary diagram of a polaroid provided by an embodiment of the present invention.

FIG. 4 is an exemplary diagram of a polaroid provided by another embodiment of the present invention.

### DETAILED DESCRIPTION OF PREFERRED EMBODIMENTS

In order to make the objects, technique solutions and advantages of the present invention be clearer, the present invention will now be described more specifically by referring to the following embodiments with the attached drawings.

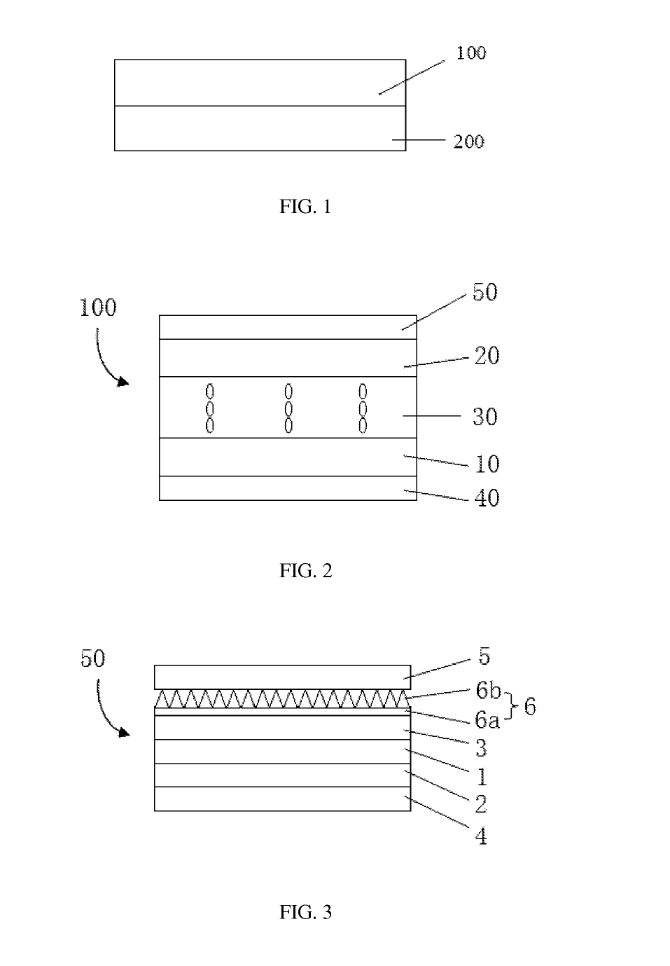

As shown in FIG. 1, the liquid crystal display apparatus provided by the present embodiment comprises a liquid crystal panel 100 and a backlight module 200. The liquid crystal panel 100 is disposed oppositely to the backlight module 200. The backlight module 200 provides a display light source to the liquid crystal panel 100 to display an image by the liquid crystal panel 100.

Wherein, as shown in FIG. 2, the liquid crystal panel 100 comprises a thin film transistor (TFT) substrate 10, a color filter (CF) substrate 20 disposed oppositely to the thin film transistor substrate 10 and a liquid crystal layer 30 disposed between the thin film transistor substrate 10 and the color filter substrate 20. In the embodiment, a vertical alignment (VA) mode is adopted for the liquid crystal layer 30. The thin film transistor substrate 10 is coupled to a first polaroid 40, and the color filter substrate 20 is coupled to a second polaroid 50.

As shown in FIG. 3, the second polaroid 50 comprises a first protecting film 2, a polarizing film 1, a second protecting film 3, a rough structure layer 6 and a surface protecting film which are stacked. In the embodiment, referring to FIG. 3, the rough structure layer 6 at least comprises a plane 6a and a rough surface 6b, wherein the plane 6a is coupled to the second protecting film 3, and the rough surface 6b is coupled to the surface protecting film 5. Through improving the structure of the polaroid at the light exit surface of the liquid crystal panel by primarily adding a rough structure layer in the polaroid, the diffuse reflection of the emitted light is generated after reflecting and refracting the emitted light by the rough structure layer to improve the uniformity of the emitted light, increase the contrast and definition of the liquid crystal panel under large viewing angle, and solves the color shifting problem of the liquid crystal panel occurred under different viewing angles.

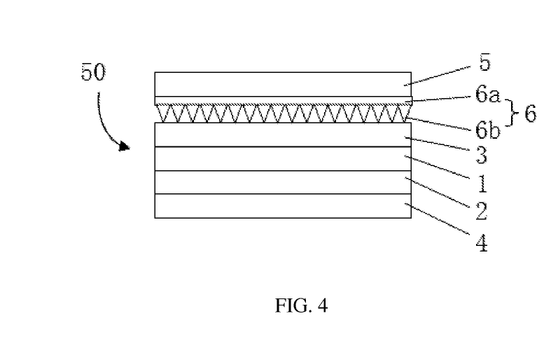

In another embodiment, as shown in FIG. 4, the plane 6a of the rough structure layer 6 is coupled to the surface protecting film 5, and the rough surface 6b is coupled to the second protecting film 3. In this embodiment, the rough surface 6b is disposed toward the liquid crystal layer 30, so that the diffuse reflection caused by the rough surface of the polaroid under the situation of a black mode of the liquid crystal panel can be reduced, and the color washout problem of the panel can be avoided.

Furthermore, in the embodiment described above, a material of the rough structure layer 6 is a transparent material. The rough surface 6b could be a zigzag structure formed on a surface of the structure layer through a rubbing process, and the zigzag structure could bean array structure arranged transversely and/or longitudinally; or the rough surface 6b could be a bump-like array formed on the surface of the structure layer through an etching process.

Refer to FIG. 3 and FIG. 4, the polaroid 50 provided by the embodiment of the present invention further comprises an adhesive layer 4, and the adhesive layer 4 is coupled to one side of the first protecting film 2, which is opposite to one side of the first protecting film coupling the polarizing film 1. The polaroid 50 is coupled to the color filter substrate 20 through the adhesive layer 4. The material of the adhesive layer 4 could be chosen to be a pressure sensitive adhesive (PSA).

Furthermore, in the embodiment described above, the material of the polarizing film 1 is polyvinyl alcohol (PVA), and the material of the first protecting film 2 and the second protecting film 3 is triacetyl cellulose (TAC). The TAC protecting films 2 and 3 are primary for protecting the PVA polarizing film 1 in order to improve a mechanical behavior of the PVA polarizing film 1 and prevent the PVA polarizing film 1 from retracting

In summary, in the embodiment of the present invention, the structure of the polaroid at the light exit surface of the liquid crystal panel is improved by primarily adding a rough structure layer in the polaroid, such that the diffuse reflection of the emitted light is generated after reflecting and refracting the emitted light by the rough structure layer to improve the uniformity of the emitted light, increase the contrast and definition of the liquid crystal panel under large viewing angle, and solves the color shifting problem of the liquid crystal panel occurred under different viewing angles. Specifically, the rough structure layer at least comprises a plane and a rough surface. When the rough surface is disposed toward the liquid crystal layer, the diffuse reflection caused by the rough surface of the polaroid under the situation of a black mode of the liquid crystal panel can be reduced, and the color washout problem of the panel can be avoided.

It should be noted that, in the present disclosure, the relative terms such as first and second are only for distinguishing one object or operation from another object or operation, but not for requiring the real relationships or orders between these objects or operations. Furthermore, the terms of “comprising”, “including” or other variations are meant to cover nonexclusive including, such that the processes, methods, objects or equipment including a plurality of elements do not only include these elements but also include other elements which are non-obviously listed, or include the basic elements which have to be existed in the processes, methods, objects or equipment. Under the situation of no more limitations, the processes, methods, objects or equipment including an element limited by the term of “comprising a . . . ” do not exclude the possibility of other existence of the same element therein.

Those described above are the embodiments of the present application. It is noted that various improvements and modifications can be made within the theory of the present application by those with ordinary skill in the technique field, and these improvements and modifications should be included in the protection scope of the present application.

What is claimed is:

1. A polaroid comprising a first protecting film, a polarizing film and a second protecting film which are stacked, wherein a rough structure layer and a surface protecting film are sequentially disposed above the second protecting film.

2. The polaroid according to claim 1, wherein the rough structure layer at least comprises a plane and a rough surface, the plane is coupled to the second protecting film, and the rough surface is coupled to the surface protecting film.

3. The polaroid according to claim 1, wherein the rough structure layer at least comprises a plane and a rough surface, the plane is coupled to the surface protecting film, and the rough surface is coupled to the second protecting film.

4. The polaroid according to claim 1, wherein the polaroid further comprises an adhesive layer which coupled to a side of the first protecting film opposite to the polarizing film.

5. The polaroid according to claim 4, wherein a material of the polarizing film is polyvinyl alcohol.

6. The polaroid according to claim 4, wherein a material of the first protecting film and the second protecting film is triacetyl cellulose, and the material of the adhesive layer is pressure sensitive adhesive.

7. The polaroid according to claim 4, wherein a material of the rough structure layer is transparent material; the rough surface is a zigzag structure formed on a surface the structure layer through a rubbing process, and the zigzag structure is arranged transversely and/or longitudinally to form an array structure; or the rough surface is a bump-like array formed on the surface of the structure layer through an etching process.

8. A liquid crystal panel comprising a thin film transistor substrate, a color filter substrate disposed oppositely to the thin film transistor substrate and a liquid crystal layer disposed between the thin film transistor substrate and the color filter substrate, and the thin film transistor substrate being coupled to a first polaroid and the color filter substrate being coupled to a second polaroid, wherein the second polaroid comprises a first protecting film, a polarizing film and a second protecting film which are stacked, and a rough structure layer and a surface protecting film are sequentially disposed above the second protecting film.

9. The liquid crystal panel according to claim 8, wherein the rough structure layer at least comprises a plane and a rough surface, the plane is coupled to the second protecting film, and the rough surface is coupled to the surface protecting film.

10. The liquid crystal panel according to claim 8, wherein the rough structure layer at least comprises a plane and a rough surface, the plane is coupled to the surface protecting film, and the rough surface is coupled to the second protecting film.

11. The liquid crystal panel according to claim 8, wherein the second polaroid further comprises an adhesive layer which coupled to a side of the first protecting film opposite to the polarizing film.

12. The liquid crystal panel according to claim 11, wherein a material of the polarizing film is polyvinyl alcohol, the material of the first protecting film and the second protecting film is triacetyl cellulose, and the material of the adhesive layer is pressure sensitive adhesive.

13. The liquid crystal panel according to claim 11, wherein a material of the rough structure layer is transparent material; the rough surface is a zigzag structure formed on a surface of the structure layer through a rubbing process, and the zigzag structure is arranged transversely and/or longitudinally to form an array structure; or the rough surface is a bump-like array formed on the surface of the structure layer through an etching process.

14. The liquid crystal panel according to claim 8, wherein the liquid crystal panel is a vertical alignment mode liquid crystal panel.

15. A liquid crystal display apparatus comprising a liquid crystal panel and a backlight module, the liquid crystal panel being disposed oppositely to the backlight module and a display light source being provided to the liquid crystal panel by the backlight module so as to display an image by the liquid crystal panel, wherein the liquid crystal panel comprises a thin film transistor substrate, a color filter substrate disposed oppositely to the thin film transistor substrate and a liquid crystal layer disposed between the thin film transistor substrate and the color filter substrate, and the thin film transistor substrate is coupled to a first polaroid and the color filter substrate is coupled to a second polaroid, wherein the second polaroid comprises a first protecting film, a polarizing film and a second protecting film which are stacked, and a rough structure layer and a surface protecting film are sequentially disposed above the second protecting film.

16. The liquid crystal display apparatus according to claim 15, wherein the rough structure layer at least comprises a plane and a rough surface, the plane is coupled to the second protecting film, and the rough surface is coupled to the surface protecting film.

17. The liquid crystal display apparatus according to claim 15, wherein the rough structure layer at least comprises a plane and a rough surface, the plane is coupled to the surface protecting film, and the rough surface is coupled to the second protecting film.

18. The liquid crystal display apparatus according to claim 15, wherein the second polaroid further comprises an adhesive layer which coupled to a side of the first protecting film opposite to the polarizing film.

19. The liquid crystal display apparatus according to claim 18, wherein a material of the polarizing film is polyvinyl alcohol, the material of the first protecting film and the second protecting film is triacetyl cellulose, and the material of the adhesive layer is pressure sensitive adhesive.

20. The liquid crystal display apparatus according to claim 18, wherein a material of the rough structure layer is transparent material; the rough surface is a zigzag structure formed on a surface of the structure layer through a rubbing process, and the zigzag structure is arranged transversely and/or longitudinally to form an array structure; or the rough surface is a bump-like array formed on the surface of the structure layer through an etching process.
